(19) United States
(12) Patent Application Publication
(10) Pub. No.: US 2025/0216196 A1
(43) Pub. Date: Jul. 3, 2025

(54) METHOD FOR REMOTE SENSING BLUE-GREEN WAVE BAND RATIOLOGARITHMIC WATER DEPTH RETRIEVAL OF WAVELET SPLINE INSTANTANEOUS TIDAL HEIGHT CORRECTION

(71) Applicant: GUILIN UNIVERSITY OF TECHNOLOGY, Guilin (CN)

(72) Inventors: Guoqing ZHOU, GUILIN (CN); Jiasheng XU, GUILIN (CN); Zhou TIAN, GUILIN (CN)

(73) Assignee: GUILIN UNIVERSITY OF TECHNOLOGY, Guilin (CN)

(21) Appl. No.: 19/001,364

(22) Filed: Dec. 24, 2024

(30) Foreign Application Priority Data
Dec. 29, 2023 (CN) 202311857436.8

(51) Int. Cl. G01C 13/00; G06T 7/50

(52) U.S. Cl. CPC G01C 13/008; G01C 13/004; G06T 7/50; G06T 2207/10024; G06T 2207/10032; G06T 2207/30181

(57) ABSTRACT

The present disclosure provides a method for remote sensing blue-green wave band ratio logarithmic water depth retrieval of wavelet spline instantaneous tidal height correction, and belongs to the field of remote sensing water depth retrieval. Aiming at water depth retrieval precision reduced by blue-green light and a tidal height in a remote sensing water depth retrieval process, the model fully considers a linear correlation between an attenuation ratio of the blue-green light in water and a depth, the smoothness of the tidal height, and the characteristics of consistent convergence, first-order continuous derivation and second-order continuous derivation of the tidal height with time change, and constructs the method for remote sensing blue-green wave band ratio logarithmic water depth retrieval of wavelet spline instantaneous tidal height correction, and according to Molokai experiment verification, compared with an early model, the invention improves the remote sensing water depth retrieval precision.

### CROSS-REFERENCE TO RELATED APPLICATIONS

This application claims the priority benefit of China application no. 202311857436.8 filed on Dec. 29, 2023. The entirety of the above-mentioned patent application is hereby incorporated by reference herein and made a part of this specification.

### BACKGROUND

### Technical Field

The present disclosure relates to the field of remote sensing water depth retrieval, and particularly to a method for remote sensing blue-green wave band ratio logarithmic water depth retrieval of wavelet spline instantaneous tidal height correction. In particular, the present disclosure relates to a tidal height correction method for a water depth retrieved from remote sensing.

### Description of Related Art

Gravities of the sun and the moon will lead to periodic tidal rise and fall of sea level, which will lead to a change of a water depth retrieved or measured by a remote sensing satellite image with a change of a tidal height. In order to satisfy engineering application, it is necessary to remove the tidal height from the water depth retrieved from remote sensing, so that the water depth retrieved from remote sensing is reduced to a geoid.

Under influences of cloudy, rainy, foggy and hazy weathers, shooting time of a satellite image capable of being used for effectively retrieving the water depth is not completely consistent with acquisition time of the tidal height by a tide gauge station, so that tidal height correction of the water depth retrieved from remote sensing is completely different from tidal height correction of water depths measured by multiple beams and an airborne LiDAR. For the water depths measured by the multiple beams and the airborne LiDAR, accurate tidal height data are acquired by setting up a temporary tide gauge station for the tidal height correction. However, the satellite image shooting for effectively retrieving the water depth is seriously affected by the weather and has a long period, so that it is difficult to acquire the tidal height data by setting up the temporary tide gauge station. At present, all remote sensing water depth retrieval methods are basically semi-empirical physical methods, and need prior water depth data. However, there is a tidal height difference between the prior water depth data and water depth data at a satellite transit moment, so that the tidal height needs to be corrected before being used for water depth retrieval. In addition, the water depth retrieved from the remote sensing satellite image is the water depth at the satellite transit moment, so that the influence of the tidal height needs to be eliminated, and the tidal height needs to be corrected based on the geoid before being used in engineering and navigation.

In order to solve the above problems, the present disclosure provides a method for remote sensing blue-green wave band ratio logarithmic water depth retrieval of wavelet spline instantaneous tidal height correction to retrieve the water depth.

In patents, such as CN201110089512.6: a method for predicting a tide-bound water level by combining a statistical model and a power model, CN201010139189.4: a tide predicting method, CN201410741168.8: a tide predicting method, CN201610104433.0: a tide correction method for an offshore time-lapse seismic record, CN201610255994.0: an intelligent real-time tide predicting method based on adaptive e variation particle swarm optimization, CN201910438154.1: a visual tide forecasting method based on an FVCOM model, CN202010187806.1: a method for predicting a tide at any point of an inland river through stage fitting, and CN202010469480.1: a tide water level forecasting method based on space-time correlation, the characteristics of uniform convergence, first-order continuous derivation and second-order continuous derivation of the tidal height are not considered in tidal height prediction, leading to a large error in tidal height calculation, so that an error of the retrieved water depth is increased. According to the characteristics of uniform convergence, first-order continuous derivation and second-order continuous derivation of the tidal height with time change, the present disclosure innovatively provides the method for remote sensing blue-green wave band ratio logarithmic water depth retrieval of wavelet spline instantaneous tidal height correction, which ensures a smaller error in tidal height calculation, so that remote sensing water depth retrieval precision is higher.

In patents, such as ZL201110035432.2: a water depth retrieval method based on a permeable band ratio factor, CN201910269328.6: a remote sensing water depth detection method based on residual partitioning, CN202010711999.6: a multispectral remote sensing water depth retrieval method based on an improved GWR model, CN201811623688.3: a hyperspectral remote sensing water depth retrieval method based on deep learning, ZL202110391470. 5: a tidal height correction method for remote sensing water depth retrieval, and CN202210546616.3: a shallow sea water depth retrieval method and system based on spectral stratification, the inherent characteristics that water molecules scatter a blue waveband and chlorophyll scatters a green waveband in water are not considered in water depth retrieval, leading to the problem that the error in the water depth retrieval is increased. The present disclosure not only fully considers a linear correlation between an attenuation ratio of blue-green light in water and a depth, but also considers the smoothness of the tidal height, and the characteristics of uniform convergence, first-order continuous derivation and second-order continuous derivation of the tidal height with time change.

### SUMMARY

Aiming at the problem of inaccurate calculation of a tidal height of a water depth retrieved from remote sensing, the present disclosure fully considers a linear correlation between an attenuation ratio of the blue-green light in water and a depth, the smoothness of the tidal height, and the characteristics of consistent convergence, first-order continuous derivation and second-order continuous derivation of the tidal height with time change, and provides the method for remote sensing blue-green wave band ratio logarithmic water depth retrieval of wavelet spline instantaneous tidal height correction, so as to solve the influence of the tidal height on water depth precision in the process of remote sensing water depth retrieval.

A method for remote sensing blue-green wave band ratio logarithmic water depth retrieval of wavelet spline instantaneous tidal height correction comprises the following steps:
S1: constructing a satellite image retrieval model for a water depth calculated with a geoid (1985 height datum) as a starting surface;

$$\{ \begin{matrix}{H}_{w} = {H}_{rw} - {H}_{tg} ( t ) \\ {H}_{tg} ( t ) = {H}_{T} ( t ) - {H}_{L}\end{matrix} \qquad ( 1 )$$

wherein, H_{w} is the water depth calculated with the geoid (1985 height datum) as the starting surface, H_{rw} is a water depth at a satellite transit moment, H_{tg}(t) is a tidal height from a water surface to the geoid, H_{T}(t) is a tidal height calculated with a tidal datum as a starting surface at the satellite transit moment, and H_{L} is a distance from the tidal datum to the geoid as specified by a local tidal station;
S2: retrieving the water depth H_{rw} according to a linear correlation between an attenuation ratio of blue-green light in water and a depth;

$${H}_{rw} = \frac{ln \frac{( {I}_{g} / {ρ}_{g} )}{( {I}_{b} / {ρ}_{b} )}}{( sec θ + sec ϕ ) ( {α}_{b} - {α}_{g} )} \qquad ( 2 )$$

wherein, I_{g} is a water radiation intensity of a green band, ρ_{g} is a substrate reflectivity of the green band, I_{b} is a water radiation intensity of a blue band, ρ_{b} is a substrate reflectivity of the blue band, θ is a satellite observation angle, and φ is a solar altitude angle; and
S3: calculating the tidal height H_{T}(t) with the tidal datum as the starting surface at the satellite transit moment;
S31: decomposing tidal height data by a wavelet function db1 to obtain a low-frequency coefficient, wherein,
the low-frequency coefficient W_{φ}(j,k) after decomposition is a main part of the tidal height, which approximately represents tidal height information;

$$W ( {φ}_{j , k} ( t ) ) = \frac{1}{\sqrt{n}} {\sum }_{n} {H}_{T} ( t ) {2}^{j / 2} φ ( {2}^{j} n - k ) \qquad ( 3 )$$

wherein, N represents a number of samples of the tidal height data to be converted, t represents a time stamp corresponding to the tidal height data, j represents a number of layers for conversion (j=0, 1, 2, . . . , which is a scaling factor), and k is a conversion coefficient (k=0, 1, 2, . . . 2^{j-1});
S32: carrying out interpolation according to the low-frequency coefficient of the tidal height data:
allowing that

$$W ( {φ}_{j , k} ( t ) ) = {H}_{A} ( t ) \qquad ( 4 )$$

then allowing an interpolated wavelet function f(t) to satisfy the following formula

$$\{ \begin{matrix}f ( {t}_{i} ) = {H}_{A} ( {t}_{i} ) \\ f ( {t}_{i} - 0 ) = f ( {t}_{i} + 0 ) \\ {f}^{′} ( {t}_{i} - 0 ) = {f}^{′} ( {t}_{i} + 0 ) \\ {f}^{″} ( {t}_{i} - 0 ) = {f}^{″} ( {t}_{i} + 0 ) \\ {f}^{″} ( {t}_{0} ) = {H}_{A}^{″} ( {t}_{0} ) \\ {f}^{″} ( {t}_{n} ) = {H}_{A}^{″} ( {t}_{n} )\end{matrix} \qquad ( 5 )$$

wherein tᵢ(i=0, 1, . . . n) is an equally spaced node in an interval [t₀,tₙ] in seconds; H_{A}(tᵢ) (i=0, 1, . . . n) is corresponding low-frequency tidal height data; ƒ(tᵢ−0) is a left limit of the function ƒ(t) at the node tᵢ, ƒ(tᵢ+0) is a right limit of the function ƒ(t) at the node tᵢ, ƒ′(tᵢ−0) is a left limit of a first-order derived function of the function ƒ(t) at the node tᵢ, ƒ′(tᵢ+0) is a right limit of the first-order derived function of the function ƒ(t) at the node tᵢ, ƒ″(tᵢ−0) is a left limit of a second-order derived function of the function ƒ(t) at the node tᵢ, ƒ″(tᵢ+0) is a right limit of the second-order derived function of the function ƒ(t) at the node tᵢ, ƒ″(t₀) is a second-order derived function of the function ƒ(t) at a node t₀, H_{A}″(t₀) is a second-order derived function of a function H_{A}(t) at the node t₀, ƒ″(tₙ) is a second-order derived function of the function ƒ(t) at a node tₙ, and H_{A}″(tₙ) is a second-order derived function of the function H_{A}(t) at the node tₙ;
S33: reconstructing the low-frequency tidal height data as follows

$${H}_{T}^{R} ( t ) = C {H}_{A} ( t ) W ( {φ}_{j , k} ( t ) ) \qquad ( 6 )$$

wherein H_{T}^{R}(t) is reconstructed data, and C is a constant (which is generally 1); and
S34: calculating the time stamp of the tidal height data:
converting acquisition time of the tidal height data into the time stamp in seconds

$$t = 1800 * ( 24 d + h ) + m * 60 + 2 / s \qquad ( 7 )$$

Wherein d is a number of satellite flight days, h is a number of satellite flight hours, m is a number of satellite flight minutes, and s is a number of satellite flight seconds.

The present disclosure has the beneficial effects that: existing remote sensing water depth retrieval methods do not consider a linear correlation between an attenuation ratio of the blue-green light in water and a depth, the smoothness of the tidal height, and the characteristics of consistent convergence, first-order continuous derivation and second-order continuous derivation of the tidal height with time change, leading to a large error of the water depth retrieved from the remote sensing image, while the present disclosure provides the method for remote sensing blue-green wave band ratio logarithmic water depth retrieval of wavelet spline instantaneous tidal height correction, which fully considers the linear correlation between the attenuation ratio of the blue-green light in water and the depth, the smoothness of the tidal height, and the characteristics of consistent convergence, first-order continuous derivation and second-order continuous derivation of the tidal height with time change, so as to effectively reduce the error of the water depth retrieved from the remote sensing image.

### BRIEF DESCRIPTION OF THE DRAWINGS

FIG. 1 shows a principle of geoid water depth retrieval;

FIG. 2 shows an experimental flow;

FIG. 3 shows Molokai, and layout of water depths, prior water depth data points and check points and lines thereof;

FIG. 4A and FIG. 4B shows retrieved water depths in the present disclosure and a Stumpf model;

FIG. 5A and FIG. 5B shows error distributions in research areas of the retrieved water depths in the present disclosure and the Stumpf model;

FIG. 6A, FIG. 6B and FIG. 6C shows comparison of sectional water depths for check lines between the retrieved water depths in the present disclosure and the Stumpf model and a true water depth; and

FIG. 7 shows comparison of errors of water depths for check points between the retrieved water depths in the present disclosure and the Stumpf model and the true water depth.

### DESCRIPTION OF THE EMBODIMENTS

Specific embodiments of the present disclosure are further described in detail hereinafter with reference to the drawings, comprising the principles, experiments and steps of tidal height correction of the present disclosure.

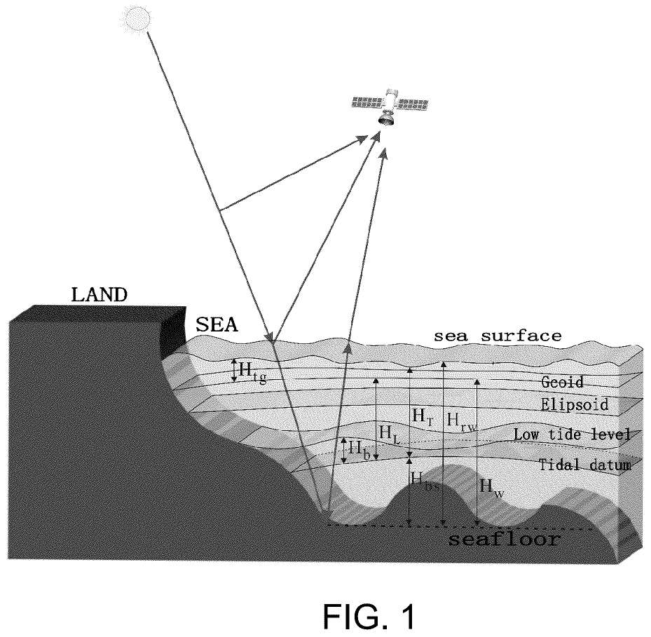

With reference to FIG. 1, during satellite flight, a tide fluctuates between high and low tide levels. A vertical distance between one point on an instantaneous sea surface and a geoid is expressed as H_{tg}, a vertical distance from one point on the instantaneous sea surface to a tidal datum is expressed as H_{T}, a vertical distance from one point on the instantaneous sea surface to a seafloor is expressed as H_{rw}, a vertical distance from the geoid to the tidal datum is expressed as H_{L}, a vertical distance from the geoid to the seafloor is expressed as H_{w}, a vertical distance from the low tide level to the tidal datum is expressed as H_{b}, and a vertical distance from the tidal datum to the seafloor is expressed as H_{bs}. Tidal height correction of existing prior water depth data (such as a water depth measured by a LiDAR and a water depth measured by multiple beams) refers to converting the H_{w} into the H_{rw}, and tidal height correction of satellite image water depth retrieval refers to converting the H_{rw} into the H_{w}.

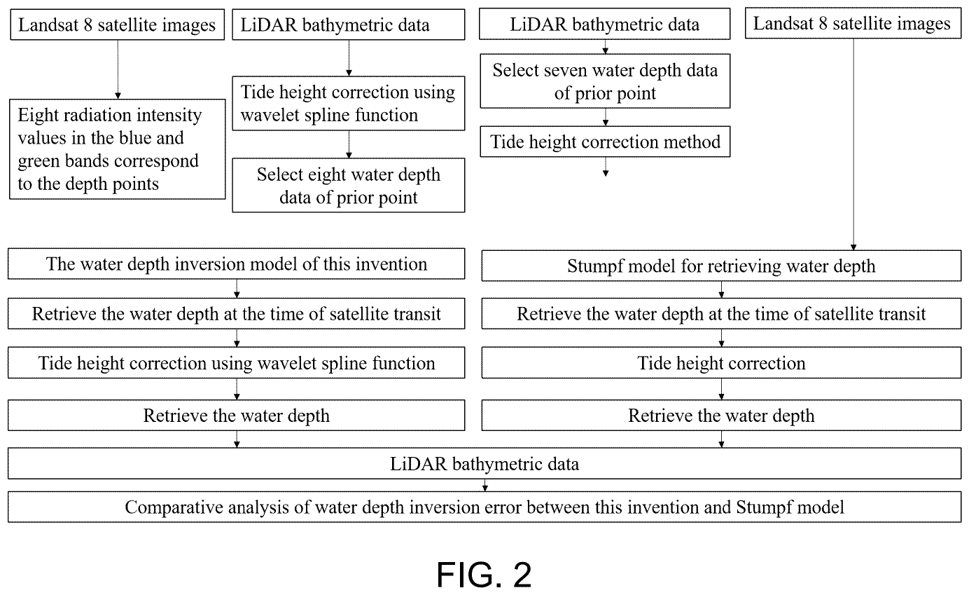

An experimental flow is described with reference to FIG. 2.

In S1, Molokai is taken as a research area in the present disclosure, and water depth data are underwater point cloud data measured by an airborne dual-frequency LiDAR SHOALS in a nearby shallow water area in October 2013 (parameters are shown in Table 1).

TABLE 1
Main parameters of SHOALS

| Parameter | Reference value |
|---|---|
| Pulse repetition frequency | 10 kHz |
| Flight height | 400 m |
| Maximum depth | 4.2/K_{d} (Bottom reflectance > 15%) |
| Minimum depth | <0.15 m |
| Water depth measurement precision | (0.09 + (0.013 depth)²)^{1/2} m, 2σ |
| Water level measurement precision | (3.5 + 0.05 depth) m, 2σ |
| Grid density | 2m × 2m |
| Scanning angle | 20° (fixed off-nadir, circular pattern) |

The experimental results are compared with those of a patent ZL202110391470. 5: a tidal height correction method for remote sensing water depth retrieval (in which a Stumpf model is used for the water depth retrieval, so that the patent is hereinafter referred to as “Stumpf model”), so as to evaluate a precision improvement ability of the present disclosure to the retrieved water depth. An experimental flow is described with reference to FIG. 2.

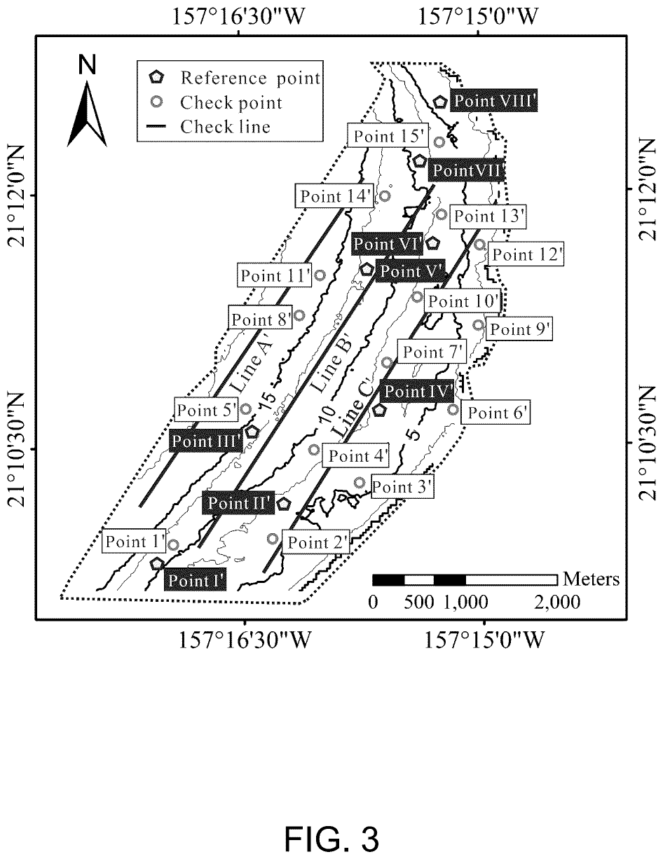

In S2, with reference to FIG. 3, according to the present disclosure, 8 prior water depth points (Point I′ to Point VIII′) for constructing a water depth retrieval model, 15 uniformly distributed check points (Point1′ to Point15′) and 3 check lines (Line A′, Line B′ and Line C′) are arranged in the research area. Meanwhile, radiometric calibration, 6S atmospheric correction and cutting of the research area are completed for Landsat8 Oil remote sensing image data to obtain a radiation intensity of a blue-green band in the research area.

In S3, tidal height data are substituted into formulas (3) to (7), and a tidal height H_{tg}(t) at a satellite transit moment is calculated to be 0.56 m by using a wavelet spline.

In S4, the water depth H_{w} measured by the LiDAR and the tidal height H_{tg}(t) at the satellite transit moment in the research area are substituted into formula (1) to be converted into the water depth H_{rw} at the satellite transit moment. The 8 prior water depth data points arranged are subjected to tidal height correction by formula (2) to acquire water depths for the 8 prior data points at the satellite transit moment, as shown in Table 2.

TABLE 2
Water depths for 8 prior water depth data points selected and water
depths for 8 prior water depth data points at satellite transit moment

| Serial | Depth of | Depth at satellite |
|---|---|---|
| number | LiDAR (m) | transit moment (m) |
| 1 | 22.45 | 21.89 |
| 2 | 13.16 | 12.60 |
| 3 | 29.63 | 29.07 |
| 4 | 15.08 | 14.52 |
| 5 | 25.76 | 25.20 |
| 6 | 15.86 | 15.30 |
| 7 | 21.88 | 21.32 |
| 8 | 13.89 | 13.33 |

In S5, parameters of the model (formula (2)) are retrieved by a least square method for radiation intensities of blue-green bands corresponding to the 8 prior water depth data points and their geographical positions to construct the water depth retrieval model of the present disclosure, and the water depths at the satellite transit moment in the research area are retrieved. Meanwhile, the water depths at the satellite transit moment in the research area are retrieved by the Stumpf model.

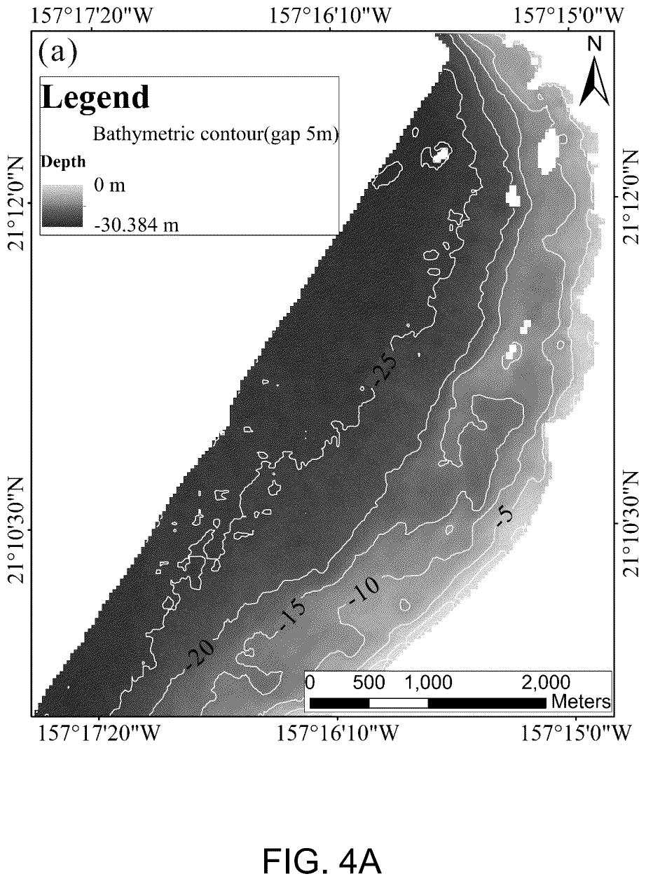

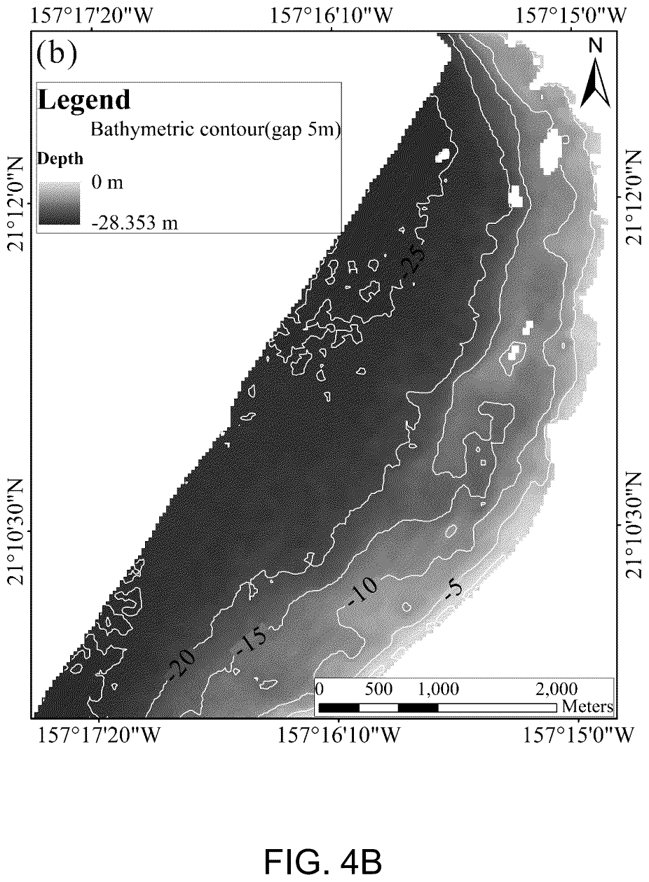

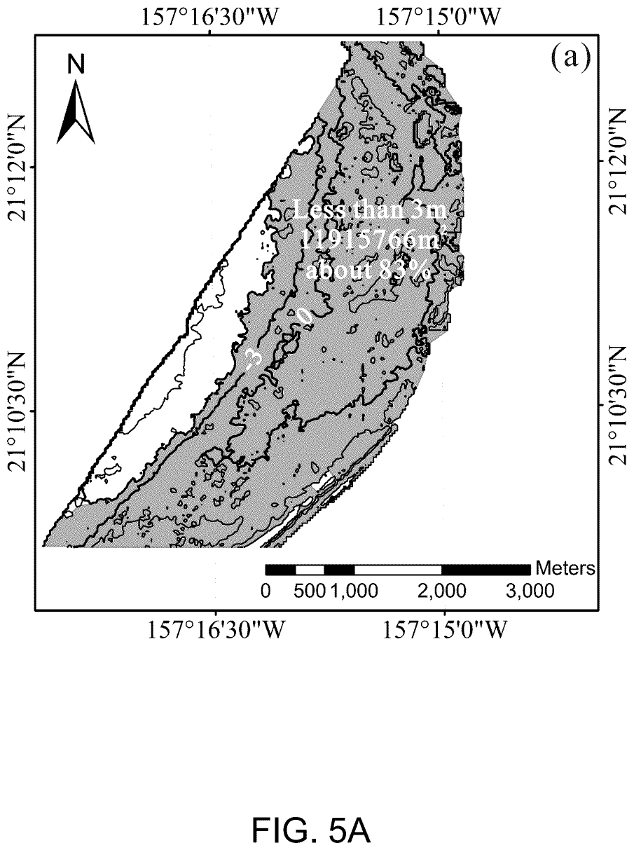

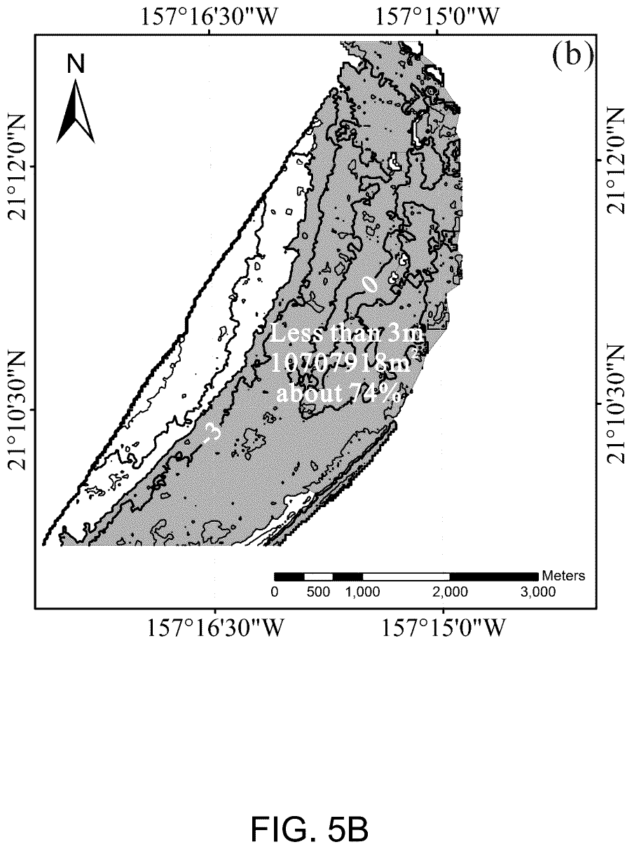

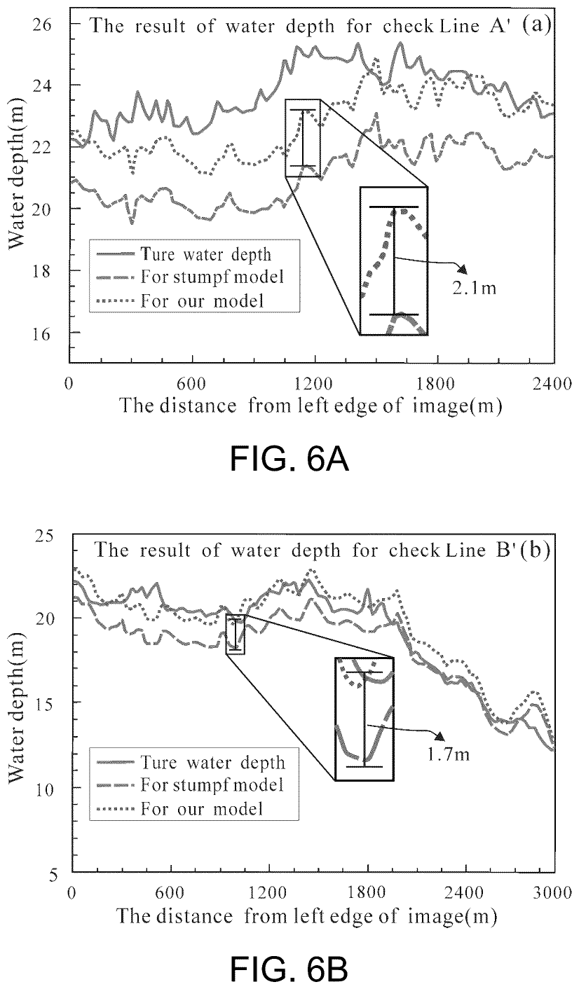

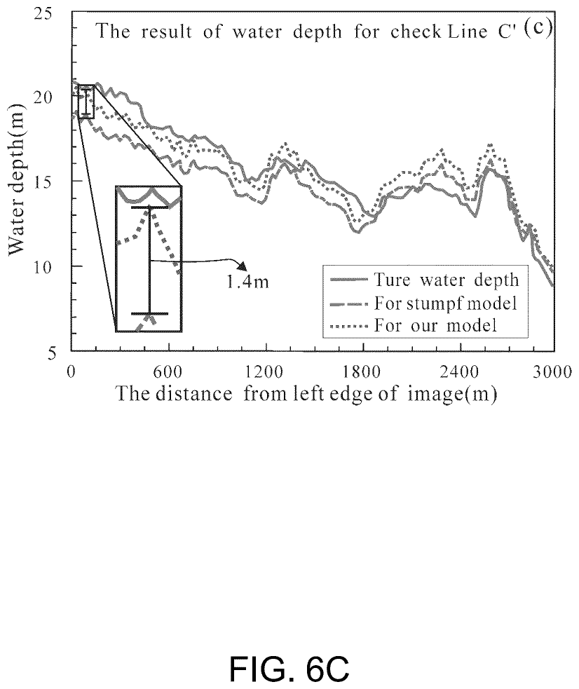

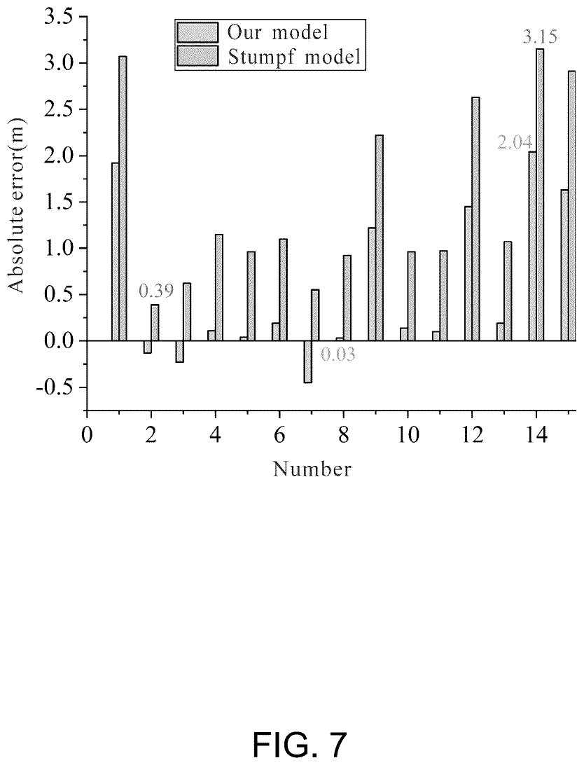

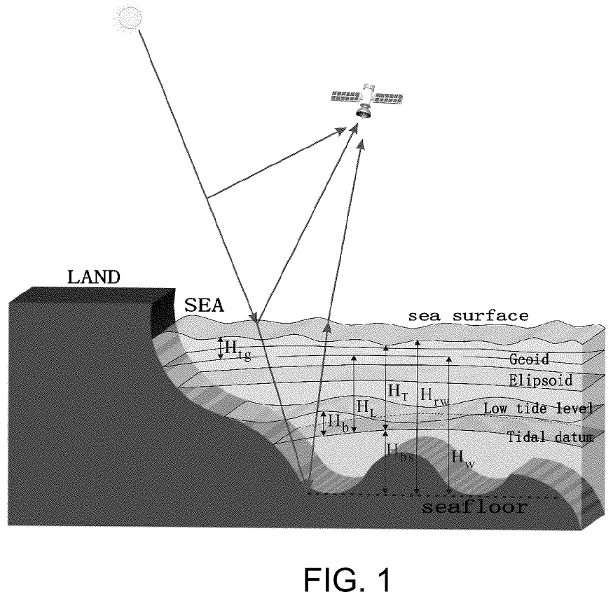

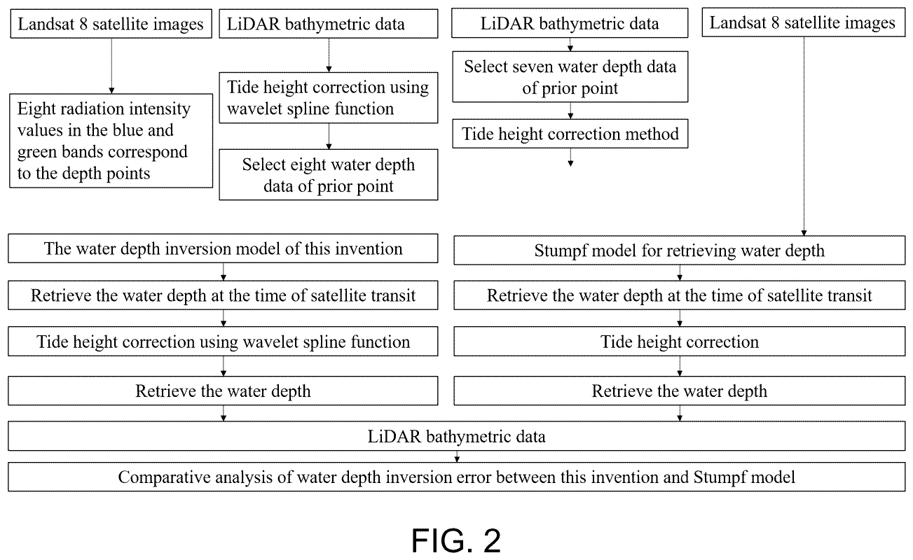

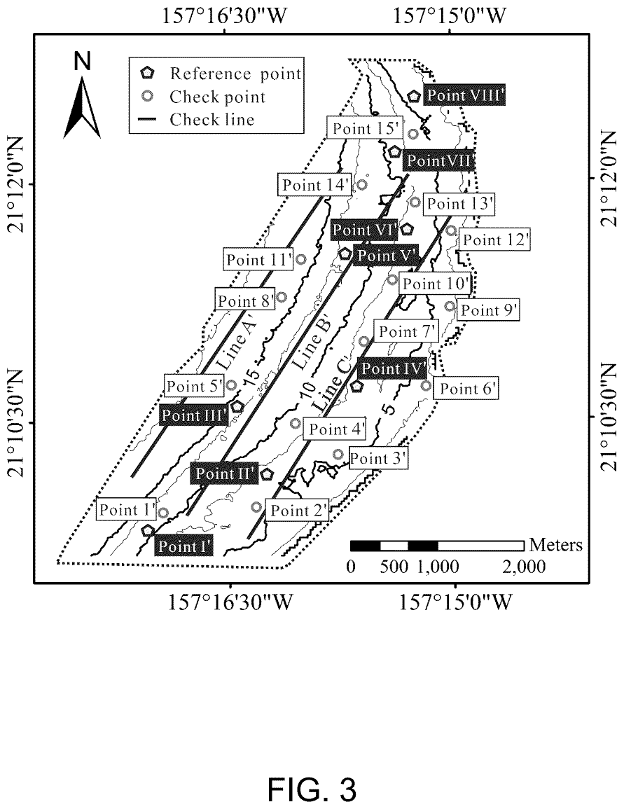

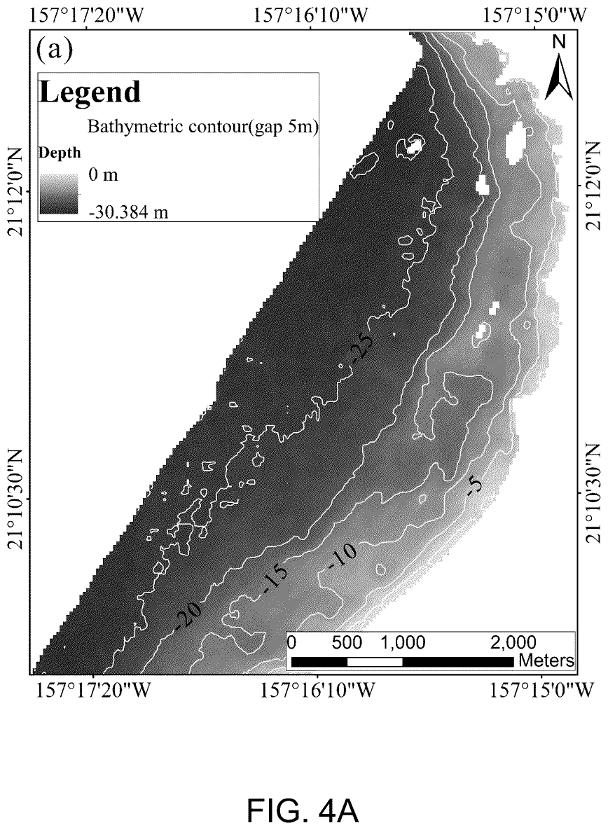

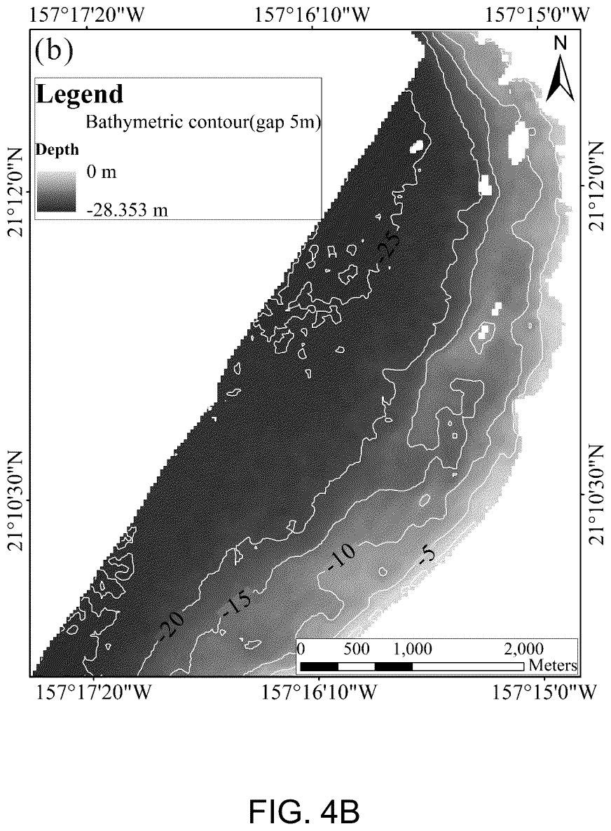

In S6, the water depths at the satellite transit moment in the research area retrieved by the present disclosure and the Stumpf model are subjected to tidal height correction according to formula (1) to obtain water depth data calculated with the geoid (1985 height datum) as the starting surface, as shown in FIG. 4A and FIG. 4B respectively.

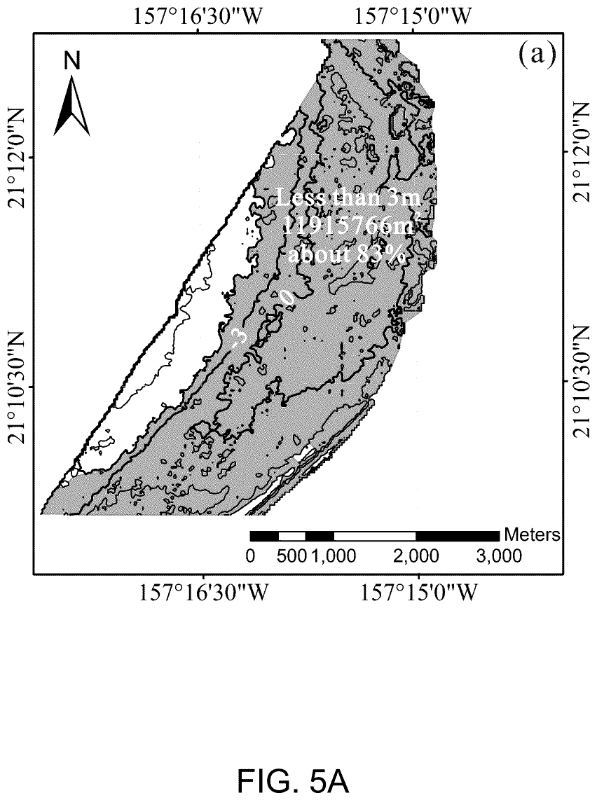

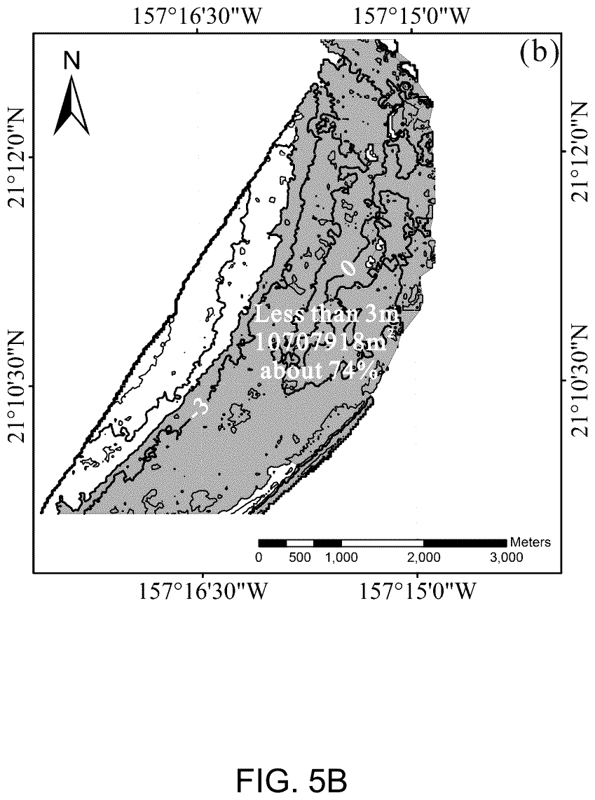

In S7, the water depths in the research area retrieved by the present disclosure and the Stumpf model are subtracted from the true water depth to obtain errors of retrieved water depths in the whole research area, and statistics show that a total area of the Molokai research area is 14316109 m², and an area with a water depth retrieval error of the Stumpf model less than 3 m is 10707918 m², accounting for about 74%; and a total area with a water depth retrieval error of the present disclosure less than 3 m is 11915766 m², accounting for about 83% (with reference to FIG. 5A and FIG. 5B). It is indicated that the precision of the present disclosure is improved by 9%.

TABLE 3
Error statistics in research area

| Model | MAE (m) | RMSE (m) |
|---|---|---|
| The present | 1.5 | 1.83 |
| disclosure | | |
| Stumpf model | 2.07 | 2.51 |
| Error reduction rate | 27.54% | 27.09% |

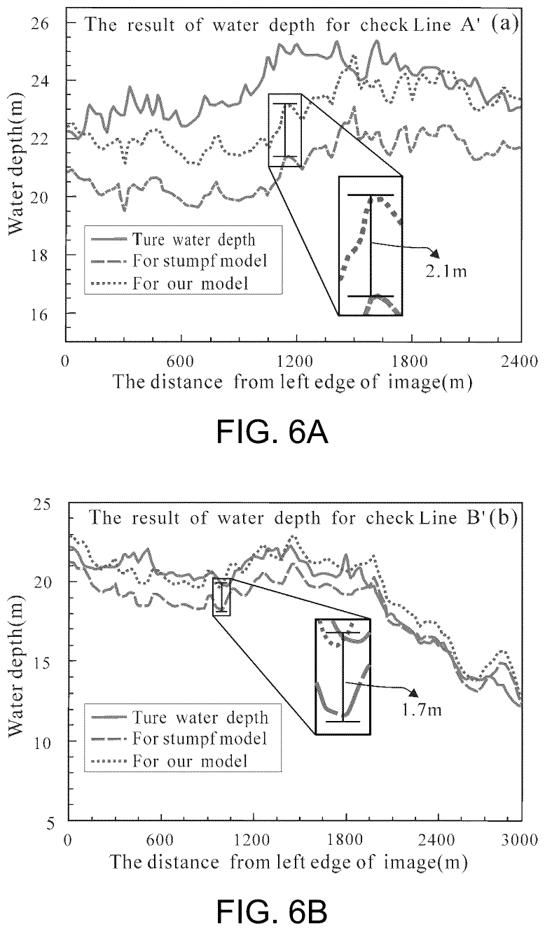

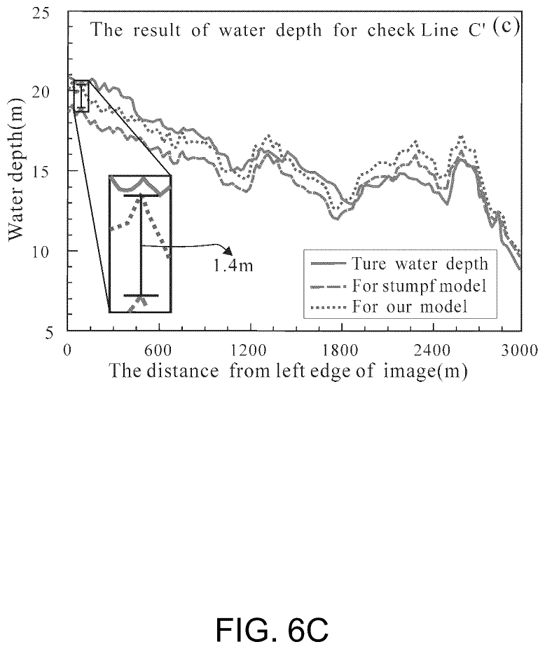

In S8, the errors of retrieved water depths in the whole research area obtained by subtracting the water depths in the research area retrieved by the present disclosure and the Stumpf model from the true water depth are counted according to the 3 check lines (with reference to FIG. 6A, FIG. 6B and FIG. 6C), wherein: minimum and average errors for the Line A′ of the present disclosure are 0 m and 1.19 m respectively, but minimum and average errors for the Line A′ of the Stumpf model are 0.98 m and 2.55 m respectively. It is indicated that the precision for the Line A′ of the present disclosure is improved by 53.3% on average compared with the precision for the Line A′ of the Stumpf model. In addition, minimum and average errors for the Line B′ are 0 m and 0.77 m respectively; and minimum and average errors for the Line C″ are 0 m and 0.62 m respectively (with reference to Table 4). It is indicated that the precision for the Line B′ and the precision for the Line C′ of the present disclosure are improved by 50% and 47.9% respectively on average.

TABLE 4
Error statistics for 3 check lines

| | The present disclosure | | | Stumpf model | | |
|---|---|---|---|---|---|---|
| | Line | Line | Line | Line | Line | Line |
| Error | A′ | B′ | C′ | A′ | B′ | C′ |
| Minimum (m) | 0 | 0 | 0 | 0.98 | 0 | 0 |
| Average (m) | 1.19 | 0.77 | 0.62 | 2.55 | 1.54 | 1.19 |

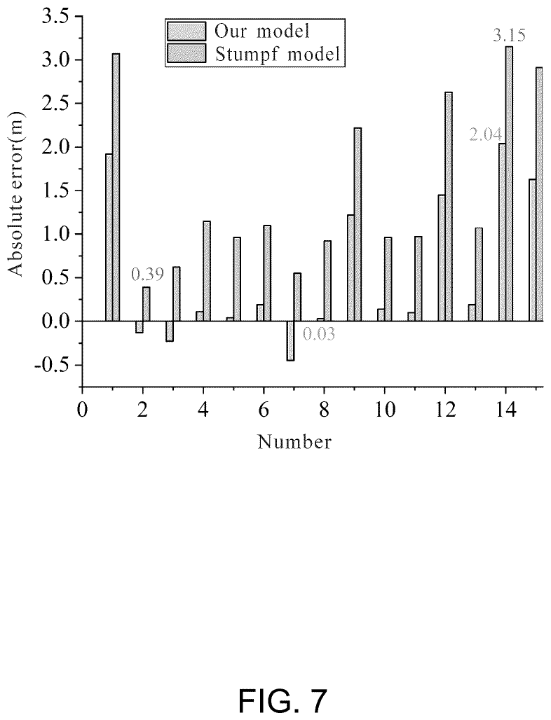

In S8, the errors of retrieved water depths in the whole research area obtained by subtracting the water depths in the research area retrieved by the present disclosure and the Stumpf model from the true water depth are counted according to the 15 check points (with reference to FIG. 7 and Table 5). It can be seen from the table that a minimum absolute error, an average absolute error, a relative average error and a root mean square error between the results of the present disclosure and the true water depth are 20.03 m, 0.66 m, 6.74% and 0.98 m respectively. However, a minimum absolute error, an average absolute error, a relative average error and a root mean square error between the results of the Stumpf model and the true water depth are 0.39 m, 1.51 m, 20.58% and 1.79 m respectively. The results show that, compared with the Stumpf model, the average absolute error, the average absolute error, the relative average error and the root mean square error of the present disclosure are reduced by 0.85 m, 13.84% and 0.81 m respectively. Therefore, the present disclosure can significantly improve the retrieved water depth.

TABLE 5
Error statistics for 15 check points

| | True | The present disclosure | | | Stumpf model | | |
|---|---|---|---|---|---|---|---|
| | water | Retrieved | | | Retrieved | | |
| Check | depth | water | Absolute | Relative | water | Absolute | Relative |
| point | (m) | depth (m) | error (m) | error (%) | depth (m) | error (m) | error (%) |
| Point1 | 13.1 | 11.18 | 1.92 | 14.66% | 10.03 | 3.07 | 23.44% |
| Point 2 | 3.0 | 3.13 | −0.13 | −4.33% | 2.61 | 0.39 | 13.00% |
| Point 3 | 3.6 | 3.83 | −0.23 | −6.39% | 2.98 | 0.62 | 17.22% |
| Point 4 | 3.9 | 3.79 | 0.11 | 2.82% | 2.75 | 1.15 | 29.49% |
| Point 5 | 5.7 | 5.66 | 0.04 | 0.70% | 4.74 | 0.96 | 16.84% |
| Point 6 | 5.4 | 5.21 | 0.19 | 3.52% | 4.30 | 1.1 | 20.37% |
| Point 7 | 7.3 | 7.75 | −0.45 | −6.16% | 6.75 | 0.55 | 7.53% |
| Point 8 | 4.8 | 4.77 | 0.03 | 0.63% | 3.88 | 0.92 | 19.17% |
| Point 9 | 8.8 | 7.58 | 1.22 | 13.86% | 6.58 | 2.22 | 25.23% |
| Point 10 | 3.3 | 3.16 | 0.14 | 4.24% | 2.34 | 0.96 | 29.09% |
| Point 11 | 4.5 | 4.4 | 0.1 | 2.22% | 3.53 | 0.97 | 21.56% |
| Point 12 | 13.4 | 11.95 | 1.45 | 10.82% | 10.77 | 2.63 | 19.63% |
| Point 13 | 4.8 | 4.61 | 0.19 | 3.96% | 3.73 | 1.07 | 22.29% |
| Point 14 | 12.4 | 10.36 | 2.04 | 16.45% | 9.25 | 3.15 | 25.40% |
| Point 15 | 15.8 | 14.17 | 1.63 | 10.32% | 12.89 | 2.91 | 18.42% |
| Average | 7.32 | 6.77 | 0.66 | 6.74% | 5.81 | 1.51 | 20.58% |
| RMSE | | 0.98 | | | 1.79 | | |

To sum up, the present disclosure can improve the water depth retrieval precision to a certain extent, so as to make the retrieved water depth closer to the true water depth, thus achieving more practical significance and value.

Although the preferred embodiments of the present disclosure have been described, those skilled in the art can make additional changes and modifications to these embodiments once they know the basic inventive concepts. Therefore, the appended claims are intended to be interpreted as including the preferred embodiments and all the changes and modifications that fall within the scope of the present disclosure.

Obviously, those skilled in the art may make various modifications and variations to the present disclosure without departing from the spirit and scope of the present disclosure. Therefore, if these modifications and variations of the present disclosure fall within the scope of the claims of the present disclosure and their equivalents, the present disclosure is also intended to include these modifications and variations.

What is claimed is:

1. A method for remote sensing blue-green wave band ratio logarithmic water depth retrieval of wavelet spline instantaneous tidal height correction, comprising the following steps:
S1: constructing a satellite image retrieval model for a water depth calculated with a geoid (1985 height datum) as a starting surface;
$$\{ \begin{matrix}{H}_{w} = {H}_{rw} - {H}_{tg} ( t ) \\ {H}_{tg} ( t ) = {H}_{T} ( t ) - {H}_{L}\end{matrix} \qquad ( 1 )$$
wherein H_{w} is the water depth calculated with the geoid (1985 height datum) as the starting surface, H_{rw} is a water depth at a satellite transit moment, H_{tg}(t) is a tidal height from a water surface to the geoid, H_{T}(t) is a tidal height calculated with a tidal datum as a starting surface at the satellite transit moment, and H_{L} is a distance from the tidal datum to the geoid as specified by a local tidal station;
S2: retrieving the water depth H_{rw} according to a linear correlation between an attenuation ratio of blue-green light in water and a depth;
$${H}_{rw} = \frac{ln \frac{( {I}_{g} / {ρ}_{g} )}{( {I}_{b} / {ρ}_{b} )}}{( sec θ + sec ϕ ) ( {α}_{b} - {α}_{g} )} \qquad ( 2 )$$
wherein I_{g} is a water radiation intensity of a green band, ρ_{g} is a substrate reflectivity of the green band, I_{b} is a water radiation intensity of a blue band, ρ_{b} is a substrate reflectivity of the blue band, θ is a satellite observation angle, and φ is a solar altitude angle; and
S3: calculating the tidal height H_{T}(t) with the tidal datum as the starting surface at the satellite transit moment;
S31: decomposing tidal height data by a wavelet function db1 to obtain a low-frequency coefficient, wherein
the low-frequency coefficient W_{φ}(j,k) after decomposition is a main part of the tidal height, which approximately represents tidal height information;
$$W ( {φ}_{j , k} ( t ) ) = \frac{1}{\sqrt{n}} {\sum }_{n} {H}_{T} ( t ) {2}^{j / 2} φ ( {2}^{j} n - k ) \qquad ( 3 )$$
wherein N represents a number of samples of the tidal height data to be converted, t represents a time stamp corresponding to the tidal height data, j represents a number of layers for conversion (j=0, 1, 2, . . . , which is a scaling factor), and k is a conversion coefficient (k=0, 1, 2, . . . 2^{j-1});
S32: carrying out interpolation according to the low-frequency coefficient of the tidal height data:
allowing that
$$W ( {φ}_{j , k} ( t ) ) = {H}_{A} ( t ) \qquad ( 4 )$$
then allowing an interpolated wavelet function f(t) to satisfy the following formula
$$\{ \begin{matrix}f ( {t}_{i} ) = {H}_{A} ( {t}_{i} ) \\ f ( {t}_{i} - 0 ) = f ( {t}_{i} + 0 ) \\ {f}^{′} ( {t}_{i} - 0 ) = {f}^{′} ( {t}_{i} + 0 ) \\ {f}^{″} ( {t}_{i} - 0 ) = {f}^{″} ( {t}_{i} + 0 ) \\ {f}^{″} ( {t}_{0} ) = {H}_{A}^{″} ( {t}_{0} ) \\ {f}^{″} ( {t}_{n} ) = {H}_{A}^{″} ( {t}_{n} )\end{matrix} \qquad ( 5 )$$
wherein tᵢ (i=0, 1, . . . n) is an equally spaced node in an interval [t₀,tₙ] in seconds; H_{A}(tᵢ) (i=0, 1, . . . n) is corresponding low-frequency tidal height data; ƒ(tᵢ−0) is a left limit of the function ƒ(t) at the node tᵢ, ƒ(tᵢ+0) is a right limit of the function ƒ(t) at the node tᵢ, ƒ′(tᵢ−0) is a left limit of a first-order derived function of the function ƒ(t) at the node tᵢ, ƒ′(tᵢ+0) is a right limit of the first-order derived function of the function ƒ(t) at the node tᵢ, ƒ″(tᵢ−0) is a left limit of a second-order derived function of the function ƒ(t) at the node tᵢ, ƒ″(tᵢ+0) is a right limit of the second-order derived function of the function ƒ(t) at the node tᵢ, ƒ″(t₀) is a second-order derived function of the function ƒ(t) at a node t₀, H_{A}″(t₀) is a second-order derived function of a function H_{A}(t) at the node t₀, ƒ″(tₙ) is a second-order derived function of the function ƒ(t) at a node tₙ, and H_{A}″(tₙ) is a second-order derived function of the function H_{A} (t) at the node tₙ;
S33: reconstructing the low-frequency tidal height data as follows
$${H}_{T}^{R} ( t ) = C {H}_{A} ( t ) W ( {φ}_{j , k} ( t ) ) \qquad ( 6 )$$
wherein H_{T}^{R}(t) is reconstructed data, and C is a constant (which is generally 1); and
S34: calculating the time stamp of the tidal height data:
converting acquisition time of the tidal height data into the time stamp in seconds
$$t = 1800 * ( 24 d + h ) + m * 60 + 2 / s \qquad ( 7 )$$
wherein d is a number of satellite flight days, h is a number of satellite flight hours, m is a number of satellite flight minutes, and s is a number of satellite flight seconds.
